(19) United States
(12) Patent Application Publication
(10) Pub. No.: US 2023/0239076 A1
(43) Pub. Date: Jul. 27, 2023

(54) Method and device for BLE audio data transmission

(71) Applicant: Nanjing Zgmicro Company Limited, Nanjing (CN)

(72) Inventor: Bin XU, Nanjing (CN)

(21) Appl. No.: 18/118,626

(22) Filed: Mar. 7, 2023

Related U.S. Application Data
(63) Continuation of application No. PCT/CN2021/095019, filed on May 21, 2021.

(51) Int. Cl. H04L 1/1607; H04W 28/04

(52) U.S. Cl. CPC H04L 1/1607; H04W 28/04

(57) ABSTRACT

A method and a device for BLE audio data transmission are disclosed. The method comprises: determining one or more data packets in a continuous burst data to be transmitted, wherein each data packet has a packet header comprising an indication for indicating a transmission mode thereof, and the transmission mode comprises a continuous burst mode; transmitting continuously the data packets in the continuous burst data within an isochronous interval to a receiving device when the indication is configured for indicating the continuous transmission mode; receiving an acknowledgement packet from the receiving device, wherein the acknowledgement packet has a packet header comprising an extended acknowledgement configured to indicate a reception of the data packets in the continuous burst data at the receiving device in batches when the indication is configured to indicate the continuous transmission mode; and determining the data packets being not correctly received in the continuous burst data based on the reception of the data packets in the continuous burst data at the receiving device.

### CROSS-REFERENCES TO RELATED APPLICATIONS

The present invention is a continuation of PCT/CN2021/095019, filed on May 21, 2021, which claims the priority of Chinese Patent Application No.: 202010931729.6 filed in China on Sep. 8, 2020, the entire contents of which are incorporated herein by reference.

### FIELD OF THE INVENTION

The present invention relates to wireless communication technology, and in particular to a method and a device for Bluetooth Low Energy (BLE) audio data transmission.

### BACKGROUND TECHNOLOGY

Bluetooth Low Energy (BLE) audio technology based on BLE connected isochronous stream (CIS) protocol provides wireless audio services with lower power consumption, lower cost and higher quality. During transmission of audio data, an actual transmission efficiency of audio data is relatively low because acknowledgements replied during the automatic retransmission will occupy additional time slots.

There is no effective solution for the low transmission efficiency of BLE audio data transmission in related technologies. Therefore, it is necessary to propose an improved technique to solve the above problems.

### SUMMARY OF THE INVENTION

The purpose of the present invention is to provide a method and a device for BLE audio data transmission, which can solve the problem of low transmission efficiency during BLE audio data transmission in the related technology.

To achieve the purpose, according to one aspect of the present invention, a method for transmitting BLE audio data transmission is provided. The method for BLE audio data transmission, comprises: determining one or more data packets in a continuous burst data to be transmitted, wherein each data packet has a packet header comprising an indication for indicating a transmission mode thereof, and the transmission mode comprises a continuous burst mode; transmitting continuously the data packets in the continuous burst data within an isochronous interval to a receiving device when the indication is configured for indicating the continuous transmission mode; receiving an acknowledgement packet from the receiving device, wherein the acknowledgement packet has a packet header comprising an extended acknowledgement configured to indicate a reception of the data packets in the continuous burst data at the receiving device in batches when the indication is configured to indicate the continuous transmission mode; and determining the data packets being not correctly received in the continuous burst data based on the reception of the data packets in the continuous burst data at the receiving device.

According to a second aspect of the present invention, a method for method for BLE audio data transmission is provided. The method for BLE audio data transmission, comprises: receiving one or more data packets in a continuous burst data transmitted continuously by a transmitting device within an isochronous interval, wherein each data packet has a packet header comprising an indication for indicating a transmission mode thereof, and the transmission mode comprises a continuous burst mode; determining a reception of the data packets in the continuous burst data based on the indication; and transmitting an acknowledgement packet to the transmitting device, wherein the acknowledgement packet has a packet header comprising an extended acknowledgement configured to indicate the reception of the data packets in the continuous burst data at the receiving device in batches when the indication is configured to indicate the continuous transmission mode.

According to a third aspect of the present invention, a device for BLE audio data transmission is provided. The device for BLE audio data transmission, comprises: a first determination module configured for determining one or more data packets in a continuous burst data to be transmitted, wherein each data packet has a packet header comprising an indication for indicating a transmission mode thereof, and the transmission mode comprises a continuous burst mode; a continuous transmitting module configured for transmitting continuously the data packets in the continuous burst data within an isochronous interval to a receiving device when the indication is configured for indicating the continuous transmission mode; a receiving module configured for receiving an acknowledgement packet from the receiving device, wherein the acknowledgement packet has a packet header comprising an extended acknowledgement configured to indicate a reception of the data packets in the continuous burst data at the receiving device in batches when the indication is configured to indicate the continuous transmission mode, wherein the first determination module is further configured for determining the data packets being not correctly received in the continuous burst data based on the reception of the data packets in the continuous burst data at the receiving device.

Since the extended acknowledgement in the packet header of the acknowledgement packet in the present invention can indicate the reception of the data packets in the continuous burst data at the receiving device in batches, it can solve the problem of low transmission efficiency during the BLE audio data transmission, and achieve the technical effect of saving the time of transmitting and receiving the acknowledgement packets and improving the transmission efficiency of the link.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic diagram of the BLE audio communication system as a typical application scenario of a method for BLE audio data transmission according to one embodiment of the present invention;

FIG. 2 is a flowchart of a method for BLE audio data transmission according to one embodiment of the present invention;

FIG. 3 is a flowchart of a method for BLE audio data transmission according to another embodiment of the present invention;

FIG. 4 is a schematic structural diagram of a device for BLE audio data transmission according to one embodiment in the present invention;

FIG. 5 is a schematic structural diagram of a device for BLE audio data transmission according to another embodiment in the present invention;

FIG. 6 is a schematic transmitting flowchart of a transmitting device according to one embodiment of the present invention;

FIG. 7 is a schematic receiving flowchart of a receiving device according to one embodiment of the present invention;

FIG. 8 shows a timing diagram of a first example of continuous burst and acknowledgement in batches in the present invention;

FIG. 9 shows a timing diagram of a second example of continuous burst and acknowledgement in batches in the present invention; and

FIG. 10 shows a timing diagram of a third example of continuous data and acknowledgement in batches in the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Technical terms involved in the present invention are listed as follows: Connected Isochronous Stream (CIS), Protocol Data Unit (PDU), Payload, Service Data Unit (SDU), Isochronous Physical Channel (IPCH), Reserved for Future Use (RFU), Continuous Burst (CB), Extended Acknowledgement (EACK), Isochronous Interval, Burst Number (BN), Number of Subevent (NSE), Continuous Burst Number (CBN), Continuous Burst Sequence Number (CBSN), Mapping Table (MT).

In the process of implementing the present invention, it is found that a maximum payload of protocol data unit based on isochronous physical channel of BLE audio technology is only 251 bytes. If 1 Mbps transmission rate is used, a ratio of an additional time slot occupied by an automatic retransmission acknowledgement to a time slot occupied by the maximum payload is about 10%. If 2Mbps transmission rate is used, the ratio of the additional time slot occupied by the automatic retransmission acknowledgement to the time slot occupied by the maximum payload is about 16%.

If the BLE audio uses a shorter service data unit, corresponding to a shorter PDU payload, the ratio of the additional time slot occupied by the automatic retransmission acknowledgement to the time slot occupied by the payload is greater. That is, the actual transmission efficiency of BLE audio is relatively low. In order to solve the above problems, a method for BLE audio data transmission is provided according to one embodiment of the present invention. The method comprises: determining one or more data packets in a continuous burst data to be transmitted, wherein each data packet has a packet header comprising an indication for indicating a transmission mode thereof, and the transmission mode comprises a continuous burst mode; transmitting continuously the data packets in the continuous burst data within an isochronous interval to a receiving device when the indication is configured for indicating the continuous transmission mode; receiving an acknowledgement packet from the receiving device, wherein the acknowledgement packet has a packet header comprising an extended acknowledgement configured to indicate a reception of the data packets in the continuous burst data at the receiving device in batches when the indication is configured to indicate the continuous transmission mode; and determining the data packets being not correctly received in the continuous burst data based on the reception of the data packets in the continuous burst data at the receiving device.

To facilitate the understanding of the present invention, the exemplary embodiments of the present invention are described in further detail below in conjunction with the accompanying drawings, and it is clear that the described embodiments are only a part of the embodiments of the present invention and are not an exhaustive list of all embodiments. It is to be noted that the embodiments and the features in the embodiments of the present invention can be combined with each other without conflict.

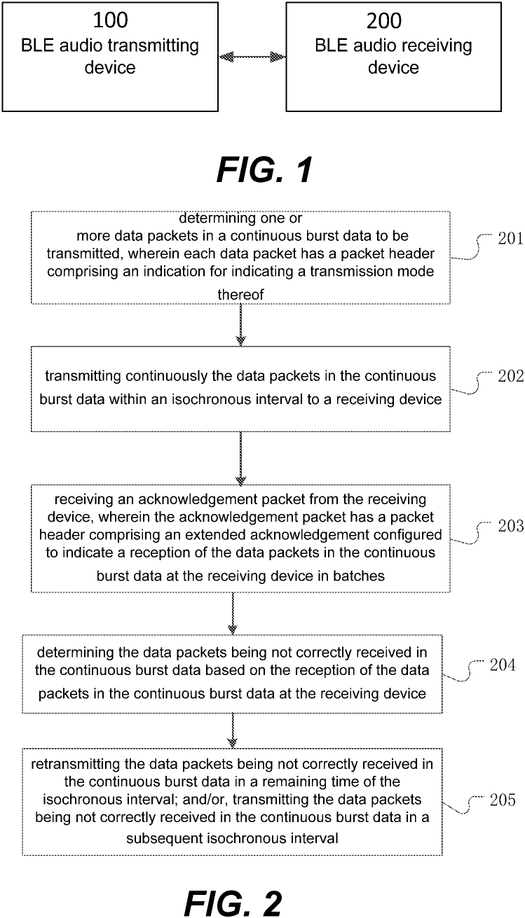

The method provided in the present invention can be performed in a Bluetooth Low Energy (BLE) audio communication system or similar communication system. FIG. 1 is a schematic diagram of the BLE audio communication system as an exemplary application scenario of the method for BLE audio data transmission according to one embodiment of the present invention. As shown in FIG. 1, the BLE audio communication system comprises a BLE audio transmitting device 100 and a BLE audio receiving device 200. The BLE audio transmitting device 100 comprises an audio encoder, a protocol processor, a wireless transceiver, and etc. The BLE audio receiving device 200 comprises: an audio decoder, a processor, a wireless transceiver, and an audio output unit, etc. The BLE audio transmitting device 100 is configured to encode and compress audio signals into encoded audio data and then transmit audio data packets to the BLE audio receiving device 200. The BLE audio receiving device 200 is configured to receive and decode the audio data packets transmitted by the BLE audio transmitting device 100 and output or play decoded audio signals.

### First Embodiment

FIG. 2 is a flowchart of the method for BLE audio data transmission according to one embodiment of the present invention. As shown in FIG. 2, the method comprises the following operations: determining one or more data packets in a continuous burst data to be transmitted at 201, wherein each data packet has a packet header comprising an indication for indicating a transmission mode thereof; transmitting continuously the data packets in the continuous burst data within an isochronous interval to a receiving device at 202; receiving an acknowledgement packet from the receiving device at 203, wherein the acknowledgement packet has a packet header comprising an extended acknowledgement configured to indicate a reception of the data packets in the continuous burst data at the receiving device in batches; determining the data packets being not correctly received in the continuous burst data based on the reception of the data packets in the continuous burst data at the receiving device at 204.

By using the BLE audio data transmission method provided according to one embodiment of the present invention, the data packets in the continuous burst data can be transmitted continuously in burst and the reception of the continuous burst data can be confirmed in batch. Thus, the problem of low transmission efficiency for the BLE audio data transmission can be solved, and the technical effect of saving the time of transmitting and receiving acknowledgement packets and improving the transmission efficiency of the link can be achieved.

In one embodiment, as shown in FIG. 2, the method further comprises: retransmitting the data packets being not correctly received in the continuous burst data in a remaining time of the isochronous interval; and/or, transmitting the data packets being not correctly received in the continuous burst data in a subsequent isochronous interval at 205. For example, the data packets that have not been correctly received can be retransmitted within the remaining time of the current isochronous interval, or within a transmission time window for a predetermined maximum transmission delay limit. If the remaining time of the current isochronous interval is insufficient, some of the data packets that have not been correctly received may also be retransmitted within the remaining time of the current isochronous interval, and other of the data packets that have not been correctly received may be retransmitted within a subsequent isochronous interval. The transmission time window for the predetermined maximum transmission delay limit may comprise one or more isochronous intervals, and may be determined according to an actual implementation scenario. Thus, the function of continuous burst transmission, batch acknowledgement, and automatic retransmission can be realized during the BLE data transmission to improve the effective transmission rate or throughput.

The continuous burst data comprises one or more data packets. In particular, a plurality of data packets in the continuous burst data will be continuously transmitted in burst. Optionally, the data packets in the continuous burst data to be transmitted comprise: the data packets (referred to as retransmitted data packets) being not correctly received at the receiving device during a previous isochronous interval and being needed to be retransmitted during a current isochronous interval, and one or more new data packets being needed to be transmitted during the current isochronous interval.

In one specific implementation, the packet header of the data packet may be designed according to the BLE protocol and use a packet header in the format of CIS Data PDU or CIS NULL PDU. The indication for indicating the transmission mode of the data packet may comprise one or more of the information related to the transmission mode such as whether it is a continuous transmission mode, a continuous burst number contained in the continuous burst data, and a continuous burst sequence number of the data packet in the continuous burst data during transmission, etc. The continuous burst number represents the number of data packets contained in the continuous burst data, and the continuous burst sequence number represents the sequence number of the data packet in the continuous burst data during continuous burst transmission.

In one specific implementation, the indication carries information for indicating whether it is the continuous transmission mode and the continuous burst sequence number of the data packet in the continuous burst data. In another specific implementation, the indication comprises the continuous burst number contained in the continuous burst data and the continuous burst sequence number of each data packet in the continuous burst data.

In a preferred embodiment, the indication is configured by an extended byte. Specifically, when the indication is configured for indicating the continuous transmission mode, a first field is added to the packet header of the data packet, wherein the first field contains the continuous burst number contained in the continuous burst data where the data packet is located, and the continuous burst sequence number of each data packet in the continuous burst data. It can be seen that the first field can be considered as an extended byte of the indication, for carrying the details of the indication. The first field comprises one byte or more bytes depending on the amount of detail of the indication, such as the continuous burst number contained in the continuous burst data. When the indication is configured for a non-continuous transmission mode, the first field is not added to the packet header of the data packet. That is, the packet header of the data packet does not contain the continuous burst number contained in the continuous burst data and the continuous burst sequence number of each data packet in the continuous burst data. By adding the first field to the packet header of the data packet, it is possible to change the information carried in the packet header of the data packet in different cases where the indication is configured for indicating the continuous transmission mode (referred to as continuous burst mode) or the non-continuous transmission mode (referred to as non-continuous burst mode).

In a specific implementation, one bit of the reserved bits in the indication is used to indicate whether the data packets are transmitted in the continuous transmission mode according to the BLE CIS protocol. If yes, the bit is set to 1 and the packet header is increased by one field, such as one byte. The high 4 bits of the one byte indicate the continuous burst number and the low 4 bits of the one byte indicate the continuous burst sequence number of the current data packet. If not, the bit is set to 0 and the packet header is not increased by the one field, the data packet is transmitted in the continuous transmission mode.

At 202, all data packets in the continuous burst data to be transmitted are transmitted continuously in burst to the receiving device within one isochronous interval. In a specific implementation, the extended acknowledgement may be configured to indicate the reception of the data packets in the data continuous burst at the receiving device in batches. For example, the extended acknowledgement contains the continuous burst sequence number of the data packets that have been correctly received and/or not correctly received. Then, at 204, the continuous burst sequence number of the data packets that has been correctly received and/or not correctly received can be obtained based on the extended acknowledgement of the acknowledgement packet, and thus the data packets in the continuous burst data that have not been correctly received at the receiving device can be determined.

In a preferred embodiment, when the extended acknowledgement is configured to indicate the reception of the data packets in the continuous burst data at the receiving device in batches, a second field containing a mapping table of the extended acknowledgement is obtained from the packet header of the acknowledgement packet, and is configured to indicate whether each data packet in the continuous burst data have been correctly received and/or not correctly received. When the extended acknowledgement is configured to not indicate the reception of the data packets in the continuous burst data at the receiving device in batches, the second field containing a mapping table of the extended acknowledgement cannot be obtained from the packet header of the acknowledgement packet.

In one specific implementation, the data packets that have not been received correctly comprise the data packets that fail to pass check or the data packets that are lost during the data transmission process. In one specific implementation, if the acknowledgement packet is not received or not correctly received at 203, i.e., the reception of the data packets in the continuous burst data at the receiving device cannot be confirmed, it is determined that all the data packets in the continuous burst data have not been correctly received at the receiving device.

In one specific implementation, one isochronous interval may be divided into a transmitting time, a receiving time, and other time depending on the action of transmitting and receiving. The transmitting action is performed within the transmitting time, the receiving action is performed within the receiving time, and while the other time is used to perform other actions such as synchronization, control, etc. Thus, the data packets that have not been correctly received are retransmitted within the remaining time in the isochronous interval based on the above determination at 205. Each retransmission may be made with reference to the operation of 201, where all the data packets not correctly received are transmitted as a new continuous burst data in the remaining time in the isochronous interval.

In an example, the BLE audio transmitting device may be used to perform the above method to transmit the data packets of BLE audio. The continuous burst data is obtained by grouping the BLE audio, and then all retransmitted data packets to be transmitted and/or new data packets to be transmitted are transmitted continuously at the BLE audio transmitting device over a CIS link during the isochronous interval. Finally, the results of receiving the data packets are confirmed in bulk based on the extended acknowledgement replied by the BLE audio receiving device.

In one embodiment, after the receiving an acknowledgement packet from the receiving device, the method further comprises: determining the reception, comprising whether the data packets have not been correctly received and/or have been correctly received at the receiving device, of the data packets in the continuous burst data at the receiving device based on the extended acknowledgement. By determining whether the extended acknowledgement contains information that the data packets in the continuous burst data have not been received correctly and/or have been received correctly at the receiving device, it is determined whether each data packet in the continuous burst data has been received correctly. If the data packets have been received correctly, those data packets are not required to be retransmitted.

In one specific implementation, the extended acknowledgement may indicate only which data packets have not been received correctly at the receiving device, or, indicate only which data packets have been received correctly at the receiving device. In another specific implementation, the extended acknowledgement indicates which data packets have not been received correctly at the receiving device, and indicates which data packets have been received correctly at the receiving device simultaneously.

In one embodiment, the determining the data packets being not correctly received in the continuous burst data based on the reception of the data packets in the continuous burst data at the receiving device, comprises: determining the data packets being not correctly received in the continuous burst data based on the data packets being not correctly received and/or being correctly received in the continuous burst data at the receiving device, wherein the data packets being not correctly received in the continuous burst data comprises the data packets that have not been correctly received and/or cannot be confirmed as correctly received in the continuous burst data. The retransmitting the data packets being not correctly received in the continuous burst data in a remaining time of the isochronous interval, comprises: determining whether there is the remaining time within the isochronous interval; and retransmitting the data packets being not correctly received in the remaining time of the isochronous interval if there is the remaining time within the isochronous interval.

In 205, after the data packets that have not been received correctly are continuously transmitted in burst each time, the acknowledgement packet will be received. The extended acknowledgement of the acknowledgement packet is used to determine whether the currently transmitted data packets have been correctly received by the BLE audio receiving device. If the currently transmitted data packets are all received correctly, the retransmission operation are not required. If the acknowledgement packet is not received or if it is confirmed that one or more of the currently transmitted data packets is still not correctly received, the retransmission operation can be performed again.

It is determined that there is enough time left in the remaining time within the current isochronous interval to transmit the data packets that have not been received correctly. If yes, the data packets that have not been received correctly are continuously transmitted in burst within the remaining time of the equal time interval. If not, no data packets are transmitted. The data packets that have not been received correctly comprises the data packets that have not been correctly received and cannot be confirmed as correctly received.

In one embodiment, the data packets in the continuous burst data to be transmitted comprise: the data packets being not correctly received at the receiving device during a previous isochronous interval and being needed to be retransmitted during a current isochronous interval, and/or one or more new data packets being needed to be transmitted during the current isochronous interval.

If there are still data packets that have not been correctly received after the isochronous interval, the data packets that have not been correctly received can be put into the next continuous burst data and transmitted to the receiving device continuously with the new data packets in the next isochronous interval. If there are no data packets incorrectly received at the receiver after the isochronous interval, the new data packets in the next continuous burst data are transmitted continuously to the receiving device during the next isochronous interval.

### Second Embodiment

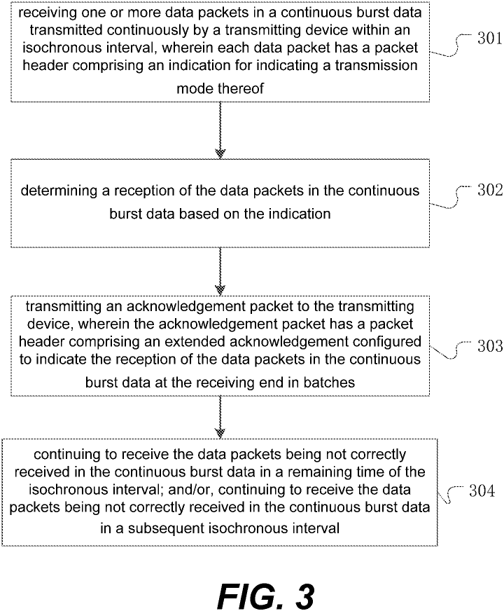

In the second embodiment, a method for BLE audio data transmission running on the BLE audio communication system shown in FIG. 1 is provided. FIG. 3 is a flowchart of the method for BLE audio data transmission according to the second embodiment of the present invention. As shown in FIG. 3, the method comprises the following operations: receiving one or more data packets in a continuous burst data transmitted continuously by a transmitting device within an isochronous interval at 301, wherein each data packet has a packet header comprising an indication for indicating a transmission mode of the data packet; determining a reception of the data packets in the continuous burst data based on the indication at 302; transmitting an acknowledgement packet to the transmitting device at 303, wherein the acknowledgement packet has a packet header comprising an extended acknowledgement configured to indicate the reception of the data packets in the continuous burst data at the receiving device in batches.

By using the BLE audio data transmission method provided according to the second embodiment of the present invention, the data packets in the continuous burst data can be transmitted continuously in burst and the reception of the continuous burst data can be confirmed in batches. Thus, the problem of low transmission efficiency for the BLE audio data transmission can be solved, and the technical effect of saving the time of transmitting and receiving the acknowledgement packets and improving the transmission efficiency of the link can be achieved.

In one embodiment, the method further comprises: continuing to receive the data packets being not correctly received in the continuous burst data in a remaining time of the isochronous interval; and/or, continuing to receive the data packets being not correctly received in the continuous burst data in a subsequent isochronous interval at 304. For example, the data packets that have not been correctly received and are retransmitted by the transmitting device can be received within the remaining time of the current isochronous interval, or within a transmission time window for a predetermined maximum transmission delay limit. If the remaining time of the current isochronous interval is insufficient, some of the data packets that have not been correctly received and retransmitted by the transmitting device may also be received within the remaining time of the current isochronous interval, and other of the data packets that have not been correctly received and retransmitted by the transmitting device may be received within a subsequent isochronous interval. The transmission time window for the predetermined maximum transmission delay limit may comprise one or more isochronous intervals, and may be determined according to an actual implementation scenario. Thus, the function of continuous burst transmission, batch acknowledgement, and automatic retransmission can be realized during the BLE data transmission to improve the effective transmission rate or throughput.

In one embodiment, the data packets in the continuous burst data that have not been correctly received and/or the data packets that have been correctly received are determined at 302 based on the indication. The indication for indicating the transmission mode of the data packet may comprise one or more information related to the transmission mode such as whether it is a continuous transmission mode, the continuous burst number contained in the continuous burst data and the continuous burst sequence number of each data packet in the continuous burst data, etc..

In one embodiment, the information indicating whether it is the continuous transmission mode, the continuous burst number contained in the continuous burst data and the continuous burst sequence number of each data packet in the continuous burst data can be obtained from the from the packet header of the data packet in the continuous burst data. Therefore, the indication is obtained from the packet header of each data packet that has been correctly received at 302. The continuous burst sequence number of each data packet that has been correctly received is determined when the indication is configured to indicate the continuous sending mode. The continuous burst sequence number of all the data packets that has been correctly received can be fed back to the transmitting device in batches at 303, so that the transmitting device can determine the data packets being not correctly received in the continuous burst data based on the continuous burst sequence number of the data packets that has been correctly received. In this embodiment, the receiving device only confirms which data packets have been received correctly, and the transmitting device determines the data packets that need to be retransmitted and have not been received correctly based on the data packets that have been received correctly.

In another specific embodiment, the indication may comprise the continuous burst number contained in the continuous burst data and the continuous burst sequence number of each data packet in the continuous burst data. Thus, in 302, the indication is obtained from the packet header of each data packet that has been correctly received. When the continuous burst number is greater than 1, it is confirmed that the current transmission mode is the continuous burst mode, and all data packets being correctly received and the data packets being incorrectly received are determined based on the continuous burst number and the continuous burst sequence number.

In a preferred embodiment, when obtaining the indication configured by the extended bytes from the packet headers of the data packets in the continuous burst data, it is also possible to obtain the continuous burst number contained in the continuous burst data and the continuous burst sequence number of each data packet in the continuous burst data from the extended bytes. Thus, the indication is obtained from the packet header of each packet that has been correctly received in 302. When the indication is configured to indicate the continuous sending mode, the continuous burst number contained in the continuous burst data and the continuous burst sequence number of each data packet in the continuous burst data are obtained based on the first field in the packet header of the received data packet. Further, the reception of the data packets in the continuous burst data is determined based on the obtained continuous burst number, and the continuous burst sequence number of each data packet being correctly received. The reception of the data packets comprises which data packets have not been received correctly and/or which data packets have been received correctly. In this embodiment, the receiving device can be accurately informed the data packets being not received correctly, so that the reception status can be flexibly controlled to achieve accurate reception of retransmitted data packets in 304.

The acknowledgement packet is transmitted to the transmitting device in 303 based on the determined reception of the data packets in the continuous burst data. The acknowledgement packet has a packet header comprising an extended acknowledgement configured to indicate the reception of the data packets in the continuous burst data at the receiving device in batches.

In one specific implementation, the packet header in the acknowledgement packet may be designed according to the BLE CIS protocol and use a packet header in the format of CIS Data PDU or CIS NULL PDU.

In a specific implementation, the extended acknowledgement carried in the packet header of the acknowledgement packet for confirming the reception of the data packet may be configured such that the extended acknowledgement contains the status of the data packet being received. For example, the extended acknowledgement contains the relevant numbers of the data packets that have been correctly received and/or not correctly received.

As a preferred embodiment, the extended acknowledgement is configured by an extended byte. When the extended acknowledgement is configured to indicate the reception of the data packets in the continuous burst data in batches, a second field is added to the packet header of the acknowledgement packet. The second field contains a mapping table of the extended acknowledgement, and the mapping table is configured to indicate whether each data packet in the continuous burst data have been correctly received and/or not correctly received. When the extended acknowledgement is configured to not indicate the reception of the data packets in the continuous burst data in batches, the second field is not added to the packet header of the acknowledgement packet. The second field comprises one byte or more bytes depending on the amount of information content that needs to be fed back, such as the number of data packets that need to indicate the reception status. By adding the second field to the packet header of the acknowledgement packet, it is possible to change the data information carried in the packet header of the acknowledgement packet in different cases where the bits of the extended acknowledgment are set to a batch indication or a non- batch indication.

In specific implementation, one bit of the reserved bits of the packet header in the acknowledgement packet is used for indicating whether the extended acknowledgement is transmitted according to the BLE CIS protocol. If the one bit related to the extended acknowledgement is set to 1, one byte as the second field is added to the packet header as a mapping table of the extended acknowledgement. If the one bit related to the extended acknowledgment is set to 0, the one byte as the second field is not added to the packet header as the mapping table of the extended acknowledgement.

In a specific implementation, the mapping table is used to indicate which data packets in the continuous burst data have been received correctly, and/or which data packets in the continuous burst data have not been received correctly. The lowest bit to the highest bit of the mapping table indicates the reception of the data packet with the lowest continuous burst sequence number to the data packet with the highest continuous burst sequence number respectively. For example, if the continuous burst data comprising 8 data packets, the lowest bit of the mapping table indicates the reception of the data packet with the lowest continuous burst sequence number, the second bit of the mapping table indicates the reception of the data packet with the lower continuous burst sequence number, and so on, the highest bit of the mapping table indicates the reception of the data packet with the highest continuous burst sequence number. For example, 0 indicates that the data packet was not received correctly, and 1 indicates that the data packet was received correctly. If the mapping table is [01000101], it means that the 1st, 3rd and 7th data packets have been received correctly and all other data packets have not been received correctly.

In an example, the method is performed at the BLE audio receiving device to receive the data packets. The BLE audio receiving device receives all retransmitted data packets and/or new data packets continuously transmitted in burst by the BLE audio transmitting device during the isochronous interval via a CIS link. Then, the extended acknowledgement is replied to confirm the reception of the packets in batches based on the indication in the packet header of the data packet.

It is important to know that the data packets that have been correctly received are those data packets that have passed the check during the data communication. As an optional implementation of the present invention, the continuing to receive the data packets being not correctly received in the continuous burst data in a remaining time of the isochronous interval comprises: determining whether there is a remaining time within the isochronous interval; continuing to receive the data packets being not correctly received in the continuous burst data in the remaining time of the isochronous interval if it is determined that there is the remaining time within the isochronous interval; stopping receiving the data packets being not correctly received in the continuous burst data if it is determined that there is no remaining time within the isochronous interval or all the data packets have been correctly received. That is, if all data packets have been correctly received, then the reception is stopped during the isochronous interval. If some or all of the data packets have not been correctly received and it is determined that the transmitting device has sufficient time to transmit the data packets in the remaining time of the isochronous interval, the data packets that have not been correctly received are continued to be received during the remaining transmitting time of the isochronous interval. If the transmitting device does not have sufficient time left to transmit the data packets in the isochronous interval, the receiving device does not continue to receive.

### Third Embodiment

According to one aspect of the present invention, a BLE audio data transmitting device is provided according to a third embodiment of the present invention. As used below, the term “module” may be a combination of software and/or hardware that implements a predetermined function. Although the data transmitting device described in the following embodiments is preferably implemented in software, the implementation of hardware, or a combination of software and hardware, is also possible and conceivable.

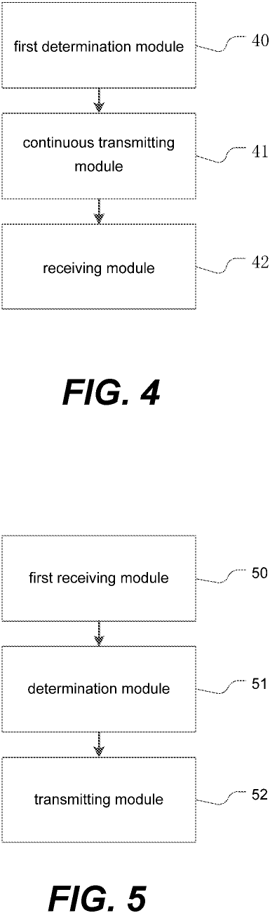

FIG. 4 is a schematic structural diagram of a device for BLE audio data transmission according to the third embodiment in the present invention. As shown in FIG. 4, the device comprises: a first determination module 40 configured for determining one or more data packets in a continuous burst data to be transmitted, wherein each data packet has a packet header comprising an indication for indicating a transmission mode thereof, and the transmission mode comprises a continuous burst mode; a continuous transmitting module 41 configured for transmitting continuously the data packets in the continuous burst data within an isochronous interval to a receiving device when the indication is configured for indicating the continuous transmission mode; a receiving module 42 configured for receiving an acknowledgement packet from the receiving device, wherein the acknowledgement packet has a packet header comprising an extended acknowledgement configured to indicate a reception of the data packets in the continuous burst data at the receiving device in batches when the indication is configured to indicate the continuous transmission mode. The first determination module 40 is further configured for determining the data packets being not correctly received in the continuous burst data based on the reception of the data packets in the continuous burst data at the receiving device.

In a specific implementation, the continuous transmitting module 41 is further configured for retransmitting the data packets being not correctly received in the continuous burst data in a remaining time of the isochronous interval; and/or, transmitting the data packets being not correctly received in the continuous burst data in a subsequent isochronous interval. The continuous burst data may have one or more data packets. In particular, a plurality of data packets in the continuous burst data will be continuously transmitted in burst.

In a specific implementation, the packet header of the data packet may be designed according to the BLE protocol and use a packet header in the format of CIS Data PDU or CIS NULL PDU. In a specific implementation, the packet header of the data packet carries the indication for indicating a preset transmission mode of the data packet. The packet header of the data packet also comprises a continuous burst number contained in the continuous burst data, and a continuous burst sequence number of each data packet in the continuous burst data.

Optionally, the data packets in the continuous burst data to be transmitted comprise: the data packets (referred to as retransmitted data packets) being not correctly received at the receiving device during a previous isochronous interval and being needed to be retransmitted during a current isochronous interval, and one or more new data packets being needed to be transmitted during the current isochronous interval.

In a specific implementation, the extended acknowledgement may be configured to indicate the reception of the data packets in the data continuous burst at the receiving device in batches. For example, the extended acknowledgement contains the continuous burst sequence number of the data packets that have been correctly received and/or not correctly received.

The packet header of the acknowledgement packet comprises a mapping table of the extended acknowledgement. The mapping table is configured to indicate whether each data packet in the continuous burst data have been correctly received and/or not correctly received. In one specific implementation, the data packets that have not been received correctly comprise the data packets that fail to pass check or the data packets that are lost during the data communication process.

In one embodiment, when the indication of the packet header of one data packet is configured to indicate the continuous transmission mode, the first determination module 40 is configured to add a first field into the packet header of the one data packet, wherein the first field comprises a continuous burst number contained in the continuous burst data where the one data packet is located, and a continuous burst sequence number of the one data packet. When the indication of the packet header of one data packet is configured to indicate a non-continuous transmission mode, the first field is not added into the packet header of the one data packet. Clearly, the data transmitting device provided in the third embodiment can be used to perform the BLE audio transmission method provided in the first embodiment. The similarities between the two are not repeated.

### Fourth Embodiment

According to another aspect of the present invention, a BLE audio data receiving device is provided according to a fourth embodiment of the present invention. As used below, the term “module” may be a combination of software and/or hardware that implements a predetermined function. Although the data transmitting device described in the following embodiments is preferably implemented in software, the implementation of hardware, or a combination of software and hardware, is also possible and conceivable.

FIG. 5 is a schematic structural diagram of the BLE audio receiving device according to another embodiment in the present invention. As shown in FIG. 5, the device comprises: a first receiving module 50 configured for receiving one or more data packets in a continuous burst data transmitted continuously by a transmitting end within an isochronous interval, wherein each data packet has a packet header comprising an indication for indicating a transmission mode thereof, and the transmission mode comprises a continuous burst mode; a determination module 51 configured for determining a reception of the data packets in the continuous burst data based on the indication; a transmitting module 52 configured for transmitting an acknowledgement packet to the transmitting end, wherein the acknowledgement packet has a packet header comprising an extended acknowledgement configured to indicate the reception of the data packets in the continuous burst data at the receiving device in batches when the indication is configured to indicate the continuous transmission mode.

In a specific embodiment, the first receiving module 50 is further configured for continuing to receive the data packets being not correctly received in the continuous burst data in a remaining time of the isochronous interval; and/or, continuing to receive the data packets being not correctly received in the continuous burst data in a subsequent isochronous interval after the transmitting an acknowledgement packet to the transmitting end.

In a specific implementation, the packet header of the data packet carries the indication for indicating a preset transmission mode of the data packet. The packet header of the data packet also comprises a continuous burst number contained in the continuous burst data, and a continuous burst sequence number of each data packet in the continuous burst data. In another specific implementation, the packet header of the data packet may be designed according to the BLE protocol and use a packet header in the format of CIS Data PDU or CIS NULL PDU.

In a specific implementation, the extended acknowledgement may contain configured to indicate the reception of the data packets in the data continuous burst at the receiving device in batches. For example, the extended acknowledgement contains the continuous burst sequence number of the data packets that have been correctly received and/or not correctly received.

The packet header of the acknowledgement packet comprises a mapping table of the extended acknowledgement. The mapping table is configured to indicate whether each data packet in the continuous burst data have been correctly received and/or not correctly received.

The determination module 51 is configured for obtaining the indication from the packet header of each data packet that has been correctly received, and the first field added in the packet header of the each data packet that has been correctly received when the indication is configured to indicate the continuous transmission mode, wherein the first field comprises a continuous burst number contained in the continuous burst data where the each data packet is located, and a continuous burst sequence number of the each data packet; determining the reception of the data packets in the continuous burst data based on the continuous burst number contained in the continuous burst data, and the continuous burst sequence number of the each data packet that has been correctly received, wherein the reception comprises whether each data packet in the continuous burst data have been correctly received and/or not correctly received.

The first receiving module 50 is further configured for determining whether there is a remaining time within the isochronous interval; stopping receiving the data packets being not correctly received in the continuous burst data if it is determined that there is no remaining time within the isochronous interval or all the data packets have been correctly received.

In an example, the BLE audio receiving device receives all retransmitted data packets and/or new data packets continuously transmitted in burst by the BLE audio transmitting device during the isochronous interval via a CIS link. Then, the extended acknowledgement is replied to confirm the reception of the packets in batches based on the indication in the packet header of the data packet. Clearly, the data receiving device provided in the fourth embodiment can be used to perform the BLE audio transmission method provided in the second embodiment. The similarities between the two are not repeated.

### Fifth Embodiment

A method for BLE audio data transmission is provided according to a fifth embodiment of the present invention. The method comprises: before transmitting a continuous burst data to the receiving device, setting a packet header of the data packets in the continuous burst data to be transmitted, wherein the packet header comprises: an indication for indicating a transmission mode thereof; and/or, an extended acknowledgement configured to indicate a reception of the data packets in the continuous burst data at the receiving device in batches. The data packets are used as the data packets in the continuous burst data transmitted continuously to the receiving device and/or as the acknowledgement packet from the receiving device during the BLE audio data transmission. That is, the same data structure can be used in the packet header of the acknowledgement packet and the data packet in the continuous burst data. The packet header with the same data structure used at the receiving device and the transmitting device can be achieved by configuring the indication or the extended acknowledgement.

In a specific implementation, in the transmitting device, the indication, not the extended acknowledgement, is comprised in the packet header. In the receiving device, the extended acknowledgement, not the indication, is comprised in the packet header. In another specific implementation, the transmitting device will also be used as the receiving device and the receiving device will also be used as the transmitting device, so that both the indication and the extended acknowledgement can be comprised in the packet header. The indication is configured to indicate the current transmission mode of the data packet to be transmitted, and the extended acknowledgement is configured to indicate in batches the reception of the data packet in the previously received continuous burst data.

As an optional implementation of the present invention, when the indication is configured for indicating the continuous transmission mode, a first field is added to the packet header of the data packet to be transmitted. The first field contains the continuous burst number contained in the continuous burst data in which this data packet is located and a continuous burst sequence number of each data packet in the continuous burst data when it is transmitted. When the indication is configured for indicating a non-continuous transmission mode, the first field is not added to the packet header of the data packet to be transmitted. When the extended acknowledgement is configured to indicate the reception of the data packets in the received continuous burst data in batches, a second field is added to the packet header. The second field contains a mapping table of the extended acknowledgement, the mapping table is configured for indicating the data packets in the received continuous burst data that have been correctly received and/or that have not been of packets correctly received. The second field is not added to the packet header when the extended acknowledgement is configured to not indicate the reception of the data packets in the received continuous burst data in batches.

As an optional implementation of the present invention, the first field comprises one byte. The high 4 bits of the one byte as the first field are used to indicate the continuous burst number contained in the continuous burst data in which this data packet is located. The low 4 bits of the one byte as the first field are used to indicate the continuous burst sequence number of each data packet in the continuous burst data when it is transmitted. The second field comprises one byte. The lowest to the highest bits of the one byte as the second field is configured to indicate the reception of the data packet with lowest continuous burst sequence number to the data packet with the highest continuous burst sequence number respectively.

The packet header in this embodiment can carry both the continuous burst transmission information and the acknowledgement information in batches. The BLE audio data transmission method using the packet header structure can realize continuous burst transmission, batch acknowledgement, and further realize the function of automatic retransmission to improve the effective transmission rate or throughput.

In order to better understand the above data transmission process, the following explanation of the above technical solution is provided in conjunction with the preferred embodiment, but is not intended to limit the technical solution of the embodiment of the present invention. In the preferred embodiment of this application, an automatic retransmission method uses continuous burst transmission of the data packets and batch acknowledgement to improve the actual transmission efficiency of BLE audio, thereby increasing its effective transmission rate or throughput.

To facilitate the automatic retransmission method of continuous burst transmission and batch acknowledgement, the indication configured for indicating the continuous transmission mode, the continuous burst number, and the continuous burst sequence number of each data packet during the continuous burst transmission are added to the packet header of the Connected Isochronous Streaming Data Protocol data unit.

The indication of the extended acknowledgement and the mapping table of the extended acknowledgement are added to the packet header of the CIS Data PDU or the Connected Isochronous Streaming Null Protocol data unit carrying the extended acknowledgement.

Specifically, as shown in Table 1, the length of the CIS PDU header is extended from 2 bytes to 2-4 bytes according to the BLE CIS protocol. Using the two reserved bits RFU in the CIS PDU header, one bit is configured to indicate whether the data packets are transmitted in the continuous burst mode, and the other bit is used as the extended acknowledgement.

TABLE 1

Header

| | | | | | | | | | | |
|---|---|---|---|---|---|---|---|---|---|---|
| LLID | NESN | SN | CIE | CB | NPI | EACK | Length | CBN | CBSN | EACK MT |
| (2 bits) | (1 bit) | (1 bit) | (1 bit) | (1 bit) | (1 bit) | (1 bit) | (8 bits) | (4 bits) | (4 bits) | (8 bits) |

Specifically, if CB (Continuous Burst) is set to 1, the CIS PDU header is increased by one byte, with the high 4 bits indicating the Continuous Burst Number (CBN) and the low 4 bits indicating the Continuous Burst Sequence Number (CBSN) in the continuous burst data during the continuous burst transmission. If CB is set to 0, the CIS PDU header is not increased by CBN and CBSN, i.e., the continuous burst transmission are not used. If EACK (Extended Acknowledgement) is set to 1, the CIS PDU header is increased by one byte to indicate the mapping table (MT) for the extended acknowledgement. If EACK is set to 0, the CIS PDU header is not increased by EACK MT, i.e., no Extended Acknowledgement is used to perform acknowledgement in batches. The EACK MT is used to indicate which data packets in the continuous burst data have been received correctly and which data packets in the continuous burst data have not been received correctly. The lowest to the highest bits of the EACK MT is configured to indicate the reception of the data packet with lowest continuous burst sequence number to the data packet with the highest continuous burst sequence number respectively.

The bits of the EACK MT corresponding to the data packets being correctly received is set to 1, and the bits of the EACK MT corresponding to the data packets being not correctly received is set to 0. If the number of data packets is less than 8, the corresponding high bits of the EACK MT are invalid.

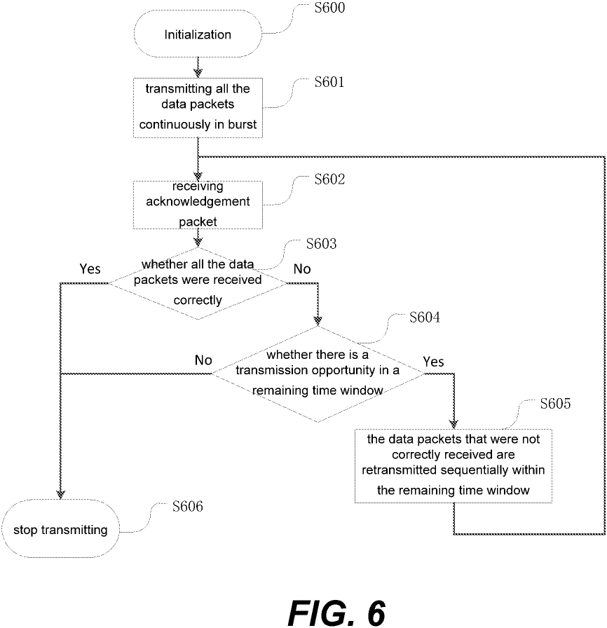

FIG. 6 is a schematic transmitting flowchart of a transmitting device according to one embodiment of the present invention. As shown in FIG. 6, the transmitting flow comprises the following operations: at S600, initialization; at S601, transmitting all the data packets in the continuously in burst; at S602, receiving an acknowledgement packet; at S603, determining whether all the data packets have been received correctly; at S604, determining whether there is a transmission opportunity in a remaining time window of the isochronous interval; at S605, the data packets that have not been correctly received are retransmitted sequentially within the remaining time window of the isochronous interval; at S606, stop transmitting.

The flow of the BLE audio transmitting devices transmitting the data packets continuously in burst is shown in FIG. 6. In each Isochronous Interval, an initialize is performed firstly, the CB of the CIS PDU header of each data packet to be transmitted in the current time window is set to 1, EACK is set to 0, and CBN is set to the number of all the data packets to be transmitted in the current time window. Then, all the data packets to be transmitted are transmitted continuously in burst within the current time window. Then, the extended acknowledgement (EACK) is received from the BLE audio receiving device. Based on the result of the received EACK, if it is confirmed that all the data packets have been correctly received by the BLE audio receiving device, the transmission is stopped.

If there are data packets that have not been correctly received or cannot be confirmed as being correctly received by the BLE audio receiving device, and it is determined that there is enough time to transmit the data packets within the current time window, the data packets that have not been correctly received are transmitted sequentially within the remaining time window. If the remaining time in the isochronous interval is not sufficient to transmit the data packets, transmission is stopped. After each successive transmission of the data packets that have not been correctly received, the acknowledgement packet is received. It is determined whether the data packets have been correctly received by the BLE audio receiving device according to the acknowledgement packet. The transmission is stopped if all the data packets have been correctly received. If the remaining time of the isochronous interval is not enough to transmit the data packet, the transmission is stopped.

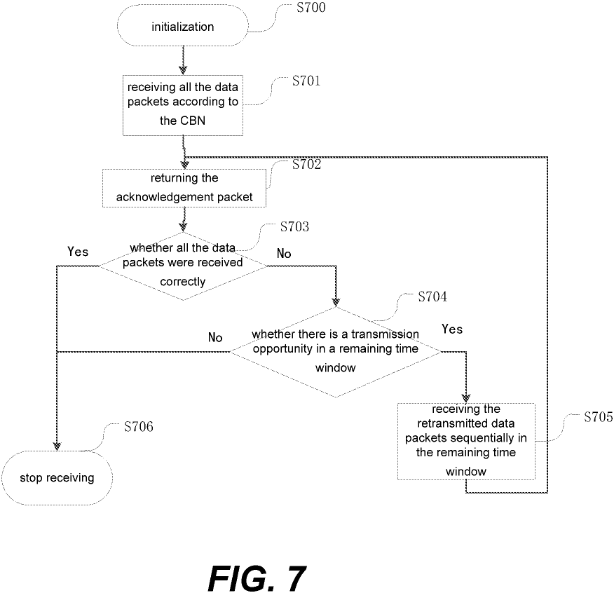

FIG. 7 is a schematic receiving flowchart of a receiving device according to one embodiment of the present invention. As shown in FIG. 7, the receiving flow comprises the following operations: at S700, initialization; at S701, receiving all the data packets according to the CBN; at S702, returning the acknowledgement packet; at S703, determining whether all the data packets have been received correctly; at S704, determining whether there is a transmission opportunity in a remaining time window of the isochronous interval; at S705, receiving the retransmitted data packets sequentially in the remaining time window; at S706, stop receiving.

Specifically, the flow of the data packet reception by the BLE audio receiving device is shown in FIG. 7. In each Isochronous Interval, an initialization is performed firstly, then all the data packets transmitted continuously in burst by the BLE audio transmitting device is received in the current time window, and the acknowledgement packet is returned according to the reception result. The CB of the CIS PDU header of the acknowledgement packet is set to 0, the EACK is set to 1, the bits of the EACK MT corresponding to the data packet correctly received is set to 1, the other bits of the EACK MT is set to 0. If all data packets indicated by the CBN of the CIS PDU header have been correctly received, the reception will be stopped within the current time window. If some or all data packets have not been received correctly, and it is determined that the BLE audio transmitting device has enough time to transmit the data packets in the current time window, then it is continuous to receive the data packets that have not been received correctly in the remaining time window. If the remaining time in the isochronous interval is not enough to transmit the data packets that have not been received correctly, the reception will be stopped.

Further, the BLE audio receiving device continues to receive the data packets that have not been correctly received within the remaining time of the current time window and then transmits another acknowledgement packet to feedback the reception result. If all data packets have been received correctly, the reception is stopped. If there are still data packets that have not been received correctly, and it is determined that the BLE audio transmitting device has enough time to transmit the data packets within the current time window, it continues to receive the data packets that have not been received correctly in the remaining time of the current time window. If the BLE audio transmitting device does not have enough transmitting time left in the isochronous interval, the reception is stopped.

Specifically, according to the BLE CIS protocol, configuration parameters of the BLE CIS link established between the BLE audio transmitting device and the BLE audio receiving device are as follows: Isochronous Interval is 40 ms, the Burst Number is 4, and the packet length is 120 bytes, BLE 2M PHY is used, the Number of Subevent (NSE) in one Isochronous Interval is 16. The air occupancy time of each packet is 540us and the Inter Frame Space (T_IFS) is 150us.

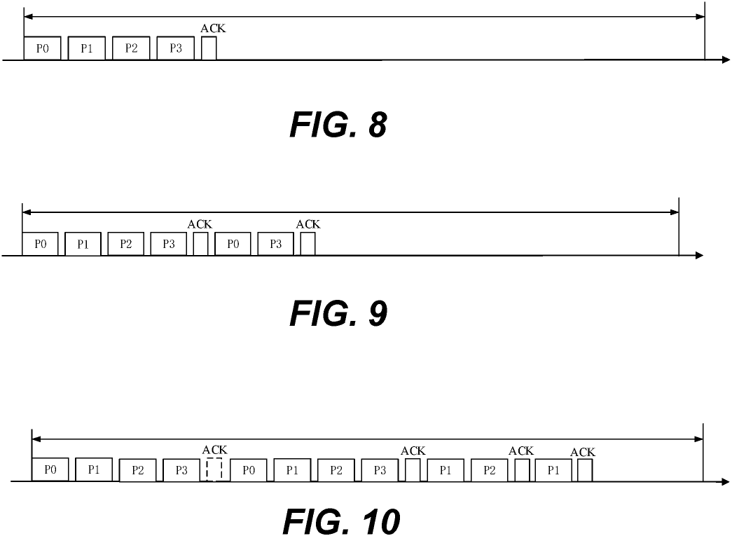

FIG. 8 to FIG. 10 show timing diagrams of three examples of continuous burst and acknowledgement in batches in the present invention. The following cases save the time of transmitting and receiving acknowledgement packets in the BLE audio system, thus increasing the effective transmission rate.

As shown in FIG. 8, within one equal time interval, the BLE audio transmitting device transmits four data packets P0, P1, P2 and P3, continuously. Wherein, the CB of CIS PDU header of each data packet is set to 1, the EACK is set to 0 and the CBN is set to 4. The CBSNs corresponding to P0, P1, P2 and P3 are set to 0, 1, 2 and 3, respectively. After the BLE audio receiving device correctly receives the 4 data packets P0, P1, P2 and P3, it replies the acknowledgement packet and stops receiving. Wherein, the CB of the CIS PDU header of the acknowledgement packet is set to 0, EACK is set to 1, and EACK MT is set to [0, 0, 0, 0, 0, 1, 1, 1, 1, 1]. After the BLE audio transmitting device correctly receives the acknowledgement packet replied by the BLE audio receiving device, it ends the transmission.

As shown in FIG. 9, within one equal time interval, the BLE audio transmitting device transmits four packets, P0, P1, P2 and P3, continuously. Wherein, the CB of the CIS PDU header of each data packet is set to 1, the EACK is set to 0 and the CBN is set to 4. The CBSNs corresponding to P0, P1, P2 and P3 are set to 0, 1, 2 and 3 respectively. The BLE audio receiving device correctly receives P1 and P2, but not correctly receives P0 and P3, the packet header of the acknowledgement packet contains the information that P1 and P2 have been correctly received, but P0 and P3 have not been correctly received. Wherein the CB of the CIS PDU header of the acknowledgement packet is set to 0, the EACK is set to 1, and the EACK MT is set to [0, 0, 0, 0, 0, 0, 0, 1, 1, 0]. The BLE Audio transmitting device retransmits the data packets P0 and P3 after correctly receiving the extended acknowledgement from the BLE Audio receiving device. Wherein, the CB of the CIS PDU header of each data packet is set to 1, the EACK is set to 0, and the CBN is set to 2. The CBSNs corresponding to P0 and P3 are set to 0 and 3, respectively. After the BLE Audio receiving device correctly receives the data packets P0 and P3, it replies the acknowledgement packet and stops receiving. Wherein, the CB of the CIS PDU header of the acknowledgement packet is set to 0, the EACK is set to 1, and the EACK MT is set to [0, 0, 0, 0, 0, 1, 1, 1, 1]. After the BLE audio transmitting device correctly receives the extended acknowledgement from the BLE audio receiving device, it ends the transmission.

As shown in FIG. 10, within one equal time interval, the BLE audio transmitting device transmits four data packets, P0, P1, P2 and P3, continuously. However, the acknowledgement packet replied by the BLE audio receiving device is not received correctly, for reasons including the BLE audio receiving device does not reply the acknowledgement packet, or the BLE audio receiving device replies the acknowledgement packet and the BLE audio transmitting does not receive the acknowledgement packet correctly. The BLE audio transmitting device will retransmit the data packets P0, P1, P2, and P3 in sequence. The CB of the CIS PDU header of each data packet is set to 1, the EACK is set to 0, and the CBN is set to 4. The CBSNs corresponding to P0, P1, P2 and P3 are set to 0, 1, 2 and 3 respectively. At this time, the BLE audio transmitting device correctly receives the acknowledgement packet replied by the BLE audio receiving device. Wherein, the CB of the CIS PDU header of the acknowledgement packet is set to 0, the EACK is set to 1, and the EACK MT is set to [0, 0, 0, 0, 0, 1, 0, 0, 1]. According to the acknowledgement packet, it is noted that the data packets P0 and P3 have been correctly received, but the data packets P1 and P2 have not been correctly received. Therefore, the BLE audio transmitting device retransmits the data packets P1 and P2. Wherein the CB of the CIS PDU header of each data packet is set to 1, the EACK is set to 0, and the CBN is set to 2. The CBSNs corresponding to P1 and P2 are set to 1 and 2, respectively. The acknowledgement packet received from the BLE audio receiving device shows only the data packet P2 is received correctly after the BLE audio transmitting device retransmits the data packets P1 and P2. Wherein, the CB of the CIS PDU the CIS PDU header is set to 0, the EACK is set to 1, and the EACK MT is set to [0, 0, 0, 0, 0, 1, 1, 0, 1]. Thus, the data packet P1 is retransmitted again. Finally, the BLE audio transmitting device receives the acknowledgement packet from the BLE audio receiving device to confirm the correct receipt of the data packet P2, and ends the transmission. Wherein, the CB of the CIS PDU header of the acknowledgement packet is set to 0, the EACK is set to 1, and the EACK MT is set to [0, 0, 0, 0, 0, 1, 1, 1, 1].

A data transmission device use as a data transmitting device is provided according to one embodiment of the present invention. The data transmission device comprises a memory and a processor in which a computer program is stored, the processor being set to run the computer program to perform the operations in any of the method described above.

In this embodiment, the processor may be set to perform the following operations through the computer program: S1, determining one or more data packets in a continuous burst data to be transmitted, wherein each data packet has a packet header comprising an indication for indicating a transmission mode thereof; S2, transmitting continuously the data packets in the continuous burst data within an isochronous interval to a receiving device; S3, receiving an acknowledgement packet from the receiving device, wherein the acknowledgement packet has a packet header comprising an extended acknowledgement configured to indicate a reception of the data packets in the continuous burst data at the receiving device in batches; S4, determining the data packets being not correctly received in the continuous burst data based on the reception of the data packets in the continuous burst data at the receiving device; S5, retransmitting the data packets being not correctly received in the continuous burst data in a remaining time of the isochronous interval.

Optionally, the specific implementation in this embodiment can refer to the description in the above embodiments and alternative embodiments, which will not be repeated here.

The data transmission device provided in the present invention is used as a BLE audio transmitting device. The BLE audio transmitting device comprises an audio encoder, a protocol processor and a BLE wireless transceiver unit. The audio encoder compresses and encodes the audio signal into audio data, the protocol processor executes the BLE protocol and the CIS protocol associated with the BLE audio transmitting device, and the BLE wireless transceiver unit is used for receiving and transmitting the BLE wireless signal and transmitting the audio data packets to the BLE audio receiving device within a limited retransmission window limited by the maximum transmission delay according to the CIS protocol.

A data transmission device use as a data receiving device is provided according to one embodiment of the present invention. The data transmission device comprises a memory and a processor in which a computer program is stored, the processor being set to run the computer program to perform the operations in any of the method described above.

In this embodiment, the processor may be set to perform the following operations through the computer program: S1, receiving one or more data packets in a continuous burst data transmitted continuously by a transmitting device within an isochronous interval, wherein each data packet has a packet header comprising an indication for indicating a transmission mode thereof; S2, determining a reception of the data packets in the continuous burst data based on the indication; S3, transmitting an acknowledgement packet to the transmitting device, wherein the acknowledgement packet has a packet header comprising an extended acknowledgement configured to indicate the reception of the data packets in the continuous burst data at the receiving device in batches; S4, continuing to receive the data packets being not correctly received in the continuous burst data in a remaining time of the isochronous interval.

Optionally, the specific implementation in this embodiment can refer to the description in the above embodiments and alternative embodiments, which will not be repeated here.

The data transmission device provided in the present invention is used as a BLE audio receiving device. The BLE audio receiving device comprises an audio decoder, a protocol processor, a BLE wireless transceiver unit and an audio output unit. The BLE audio receiving device controls the BLE wireless transceiver unit to receive and recover audio data according to the CIS protocol executed by the protocol processor, and then decode the audio data into audio signal through the audio decoder. The audio output unit is configured to output or play the decoded audio signal.

Those skilled in the art should be aware that the embodiments of the present invention may be methods, systems, or computer program products. Accordingly, the present invention may take the form of a complete hardware embodiment, a complete software embodiment, or an embodiment in conjunction with software and hardware aspects. Furthermore, the present invention may take the form of a computer program product implemented on one or more computer-available storage media (comprising, but not limited to, disk memory, CD-ROM, optical memory, etc.) containing computer-available program code.

The present invention is described with reference to methods, equipment (systems), and flow charts and/or block diagrams of computer program products according to the embodiment of the present invention. It should be understood that each flow and/or block in a flowchart and/or block diagram, as well as the combination of flow and/or block in a flowchart and/or block diagram, can be implemented by computer program instructions. These computer program instructions may be provided to a processor of a general purpose computer, a dedicated computer, an embedded processor, or other programmable data processing device to produce a machine such that instructions executed by a processor of a computer or other programmable data processing device produce instructions for implementing a flow chart or more. A device for processes and / or block diagrams or functions specified in a box or multiple boxes.

These computer program instructions may also be stored in a computer-readable memory that may guide a computer or other programmable data processing device to work in a particular way, such that the instructions stored in the computer-readable memory generate a manufacturer comprising an instruction device that is implemented in a flow chart one or more processes. Process and / or block diagram, a box or function specified in multiple boxes.

These computer program instructions may also be loaded on a computer or other programmable data processing device such that a series of operational steps are performed on a computer or other programmable device to produce computer-implemented processing, thereby providing instructions executed on a computer or other programmable device for implementing a flow chart. The steps of a process or multiple processes and / or block diagrams, or functions specified in a box.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of the present invention.

Obviously, a person skilled in the art may make various changes and variations to the application without departing from the spirit and scope of the application. Thus, if these modifications and variations of the present invention fall within the scope of the claims and their equivalent technologies, the application is also intended to comprise these changes and variations.

I claim:

1. A method for BLE audio data transmission, comprising:
determining one or more data packets in a continuous burst data to be transmitted, wherein each data packet has a packet header comprising an indication for indicating a transmission mode thereof, and the transmission mode comprises a continuous burst mode;
transmitting continuously the data packets in the continuous burst data within an isochronous interval to a receiving device when the indication is configured for indicating the continuous transmission mode;
receiving an acknowledgement packet from the receiving device, wherein the acknowledgement packet has a packet header comprising an extended acknowledgement configured to indicate a reception of the data packets in the continuous burst data at the receiving device in batches when the indication is configured to indicate the continuous transmission mode; and
determining the data packets being not correctly received in the continuous burst data based on the reception of the data packets in the continuous burst data at the receiving device.

2. The method according to claim 1, wherein after the receiving an acknowledgement packet from the receiving device, the method further comprises:
determining the reception, comprising whether the data packets have not been correctly received and/or have been correctly received at the receiving device, of the data packets in the continuous burst data at the receiving device based on the extended acknowledgement;
after the determining the data packets being not correctly received in the continuous burst data based on the reception of the data packets in the continuous burst data at the receiving device, the method further comprises:
retransmitting the data packets being not correctly received in the continuous burst data in a remaining time of the isochronous interval; and/or, transmitting the data packets being not correctly received in the continuous burst data in a subsequent isochronous interval.

3. The method according to claim 2, wherein the determining the data packets being not correctly received in the continuous burst data based on the reception of the data packets in the continuous burst data at the receiving device, comprises:
determining the data packets being not correctly received in the continuous burst data based on the data packets being not correctly received and/or being correctly received in the continuous burst data at the receiving device, wherein the data packets being not correctly received in the continuous burst data comprises the data packets that have not been correctly received and/or cannot be confirmed as correctly received in the continuous burst data;
the retransmitting the data packets being not correctly received in the continuous burst data in a remaining time of the isochronous interval, comprises:
determining whether there is the remaining time within the isochronous interval; and
retransmitting the data packets being not correctly received in the remaining time of the isochronous interval if there is the remaining time within the isochronous interval.

4. The method according to claim 1, wherein the data packets in the continuous burst data to be transmitted comprise: the data packets being not correctly received at the receiving device during a previous isochronous interval and being needed to be retransmitted during a current isochronous interval, and/or one or more new data packets being needed to be transmitted during the current isochronous interval.

5. The method according to claim 1, wherein
when the indication of the packet header of one data packet is configured to indicate the continuous transmission mode, a first field is added into the packet header of the one data packet, wherein the first field comprise a continuous burst number contained in the continuous burst data where the one data packet is located, and a continuous burst sequence number of the one data packet in the continuous burst data during transmission;
when the indication of the packet header of one data packet is configured to indicate a non-continuous transmission mode, the first field is not added into the packet header of the one data packet.

6. The method according to claim 1, wherein
when the extended acknowledgement is configured to indicate the reception of the data packets in the continuous burst data at the receiving device in batches, a second field containing a mapping table of the extended acknowledgement is obtained from the packet header of the acknowledgement packet, and is configured to indicate whether each data packet in the continuous burst data have been correctly received and/or not correctly received,
when the extended acknowledgement is configured to not indicate the reception of the data packets in the continuous burst data at the receiving device in batches, the second field containing a mapping table of the extended acknowledgement cannot be obtained from the packet header of the acknowledgement packet.

7. A method for BLE audio data transmission, comprising:
receiving one or more data packets in a continuous burst data transmitted continuously by a transmitting device within an isochronous interval, wherein each data packet has a packet header comprising an indication for indicating a transmission mode thereof, and the transmission mode comprises a continuous burst mode;
determining a reception of the data packets in the continuous burst data based on the indication; and
transmitting an acknowledgement packet to the transmitting device, wherein the acknowledgement packet has a packet header comprising an extended acknowledgement configured to indicate the reception of the data packets in the continuous burst data at the receiving device in batches when the indication is configured to indicate the continuous transmission mode.

8. The method according to claim 7, wherein the determining a reception of the data packets in the continuous burst data based on the indication, comprises:
obtaining the indication from the packet header of each data packet that has been correctly received, and a first field added in the packet header of the each data packet that has been correctly received when the indication is configured to indicate the continuous transmission mode, wherein the first field comprises a continuous burst number contained in the continuous burst data where the each data packet is located, and a continuous burst sequence number of the each data packet;
determining the reception of the data packets in the continuous burst data based on the continuous burst number contained in the continuous burst data, and the continuous burst sequence number of the each data packet that has been correctly received, wherein the reception comprises whether each data packet in the continuous burst data have been correctly received and/or not correctly received.

9. The method according to claim 8, further comprising:
generating an acknowledgement packet based on the determined reception of the data packets in the continuous burst data before the transmitting an acknowledgement packet to the transmitting device; wherein
when the extended acknowledgement is configured to indicate the reception of the data packets in the continuous burst data at the receiving device in batches, a second field containing a mapping table of the extended acknowledgement is added into the packet header of the acknowledgement packet, and is configured to indicate whether each data packet in the continuous burst data have been correctly received and/or not correctly received,
when the extended acknowledgement is configured to not indicate the reception of the data packets in the continuous burst data at the receiving device in batches, the second field containing a mapping table of the extended acknowledgement is not added into the packet header of the acknowledgement packet.

10. The method according to claim 7, further comprising: continuing to receive the data packets being not correctly received in the continuous burst data in a remaining time of the isochronous interval; and/or, continuing to receive the data packets being not correctly received in the continuous burst data in a subsequent isochronous interval after the transmitting an acknowledgement packet to the transmitting device.

11. The method according to claim 10, wherein the continuing to receive the data packets being not correctly received in the continuous burst data in a remaining time of the isochronous interval comprises:
determining whether there is a remaining time within the isochronous interval;
continuing to receive the data packets being not correctly received in the continuous burst data in the remaining time of the isochronous interval if it is determined that there is the remaining time within the isochronous interval;
stopping receiving the data packets being not correctly received in the continuous burst data if it is determined that there is no remaining time within the isochronous interval or all the data packets have been correctly received.

12. A device for BLE audio data transmission, comprising:
a first determination module configured for determining one or more data packets in a continuous burst data to be transmitted, wherein each data packet has a packet header comprising an indication for indicating a transmission mode thereof, and the transmission mode comprises a continuous burst mode;
a continuous transmitting module configured for transmitting continuously the data packets in the continuous burst data within an isochronous interval to a receiving device when the indication is configured for indicating the continuous transmission mode;
a receiving module configured for receiving an acknowledgement packet from the receiving device, wherein the acknowledgement packet has a packet header comprising an extended acknowledgement configured to indicate a reception of the data packets in the continuous burst data at the receiving device in batches when the indication is configured to indicate the continuous transmission mode,
wherein the first determination module is further configured for determining the data packets being not correctly received in the continuous burst data based on the reception of the data packets in the continuous burst data at the receiving device.

13. The device according to claim 12, wherein the continuous transmitting module is further configured for retransmitting the data packets being not correctly received in the continuous burst data in a remaining time of the isochronous interval; and/or, transmitting the data packets being not correctly received in the continuous burst data in a subsequent isochronous interval.

14. The device according to claim 12, wherein the data packets in the continuous burst data to be transmitted comprise: the data packets being not correctly received at the receiving device during a previous isochronous interval and being needed to be retransmitted during a current isochronous interval, and/or one or more new data packets being needed to be transmitted during the current isochronous interval.

15. The device according to claim 12, wherein when the indication of the packet header of one data packet is configured to indicate the continuous transmission mode, a first field is added into the packet header of the one data packet, wherein the first field comprise a continuous burst number contained in the continuous burst data where the one data packet is located, and a continuous burst sequence number of the one data packet;
when the indication of the packet header of one data packet is configured to indicate a non-continuous transmission mode, the first field is not added into the packet header of the one data packet.

16. The device according to claim 12, wherein when the extended acknowledgement is configured to indicate the reception of the data packets in the continuous burst data at the receiving device in batches, a second field containing a mapping table of the extended acknowledgement is obtained from the packet header of the acknowledgement packet, and is configured to indicate whether each data packet in the continuous burst data have been correctly received and/or not correctly received,
when the extended acknowledgement is configured to not indicate the reception of the data packets in the continuous burst data at the receiving device in batches, the second field containing a mapping table of the extended acknowledgement cannot be obtained from the packet header of the acknowledgement packet.
